(19) United States
(12) Patent Application Publication
(10) Pub. No.: US 2005/0104312 A1
(43) Pub. Date: May 19, 2005

(54) Steering pivots

(76) Inventor: Jean-Sebastien Durand, La Vancelle (FR)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/506,825

(22) PCT Filed: Feb. 28, 2003
(86) PCT No.: PCT/EP03/02072

(30) Foreign Application Priority Data
Mar. 8, 2002 (GB) 02055085

(51) Int. Cl. B60G 1/00

(52) U.S. Cl. 280/93.512

(57) ABSTRACT

There is provided a steering pivot arrangement (12) having a pivot pin (16). The pivot pin (16) provides an inner race section (17) providing an inner raceway (18). A roller cage (20) retains a number of tapered rollers (19) on the inner raceway. The cage (20) has a number of resilient inward projections (26) spaced around its periphery. The projections (26) are clipped into an annular groove (22) behind a roller abutment rib at the large end of the raceway (18).

The present invention relates to steering pivots primarily but not exclusively for the driving and steering axle of, for example, agricultural or industrial vehicles.

According to the present invention there is provided a steering pivot comprising a pivot pin providing an integrally formed radially inner race defining a circumferentially extending inner raceway, and a cage retaining therein at spaced locations rolling elements which contact the inner raceway, the cage being retained relative to the pivot pin by means of a clip connection.

Preferably there is also provided an outer race which defines a circumferentially extending outer raceway which engages the rolling elements. Conveniently, the rolling elements are tapered rollers and the inner and outer raceways are part-conical.

It is a preferred feature that the clip connection is constituted by resilient radially inward projections provided at spaced locations around the large end of the cage. The projections can be received in a circumferential groove in the large outside diameter of the inner race. Normally the large axial end of the inner raceway has a circumferential rib against which the rolling elements engage and the circumferential groove is provided immediately axially behind the rib. Preferably a seal element is provided behind the circumferential groove.

In preferred arrangements the pivot pin has a flange at its end remote from the narrow end of the inner race, the flange having a number of holes for facilitating attachment to a support arm.

Embodiments of the present invention will now be described in more detail, the description making reference to the following drawings in which:

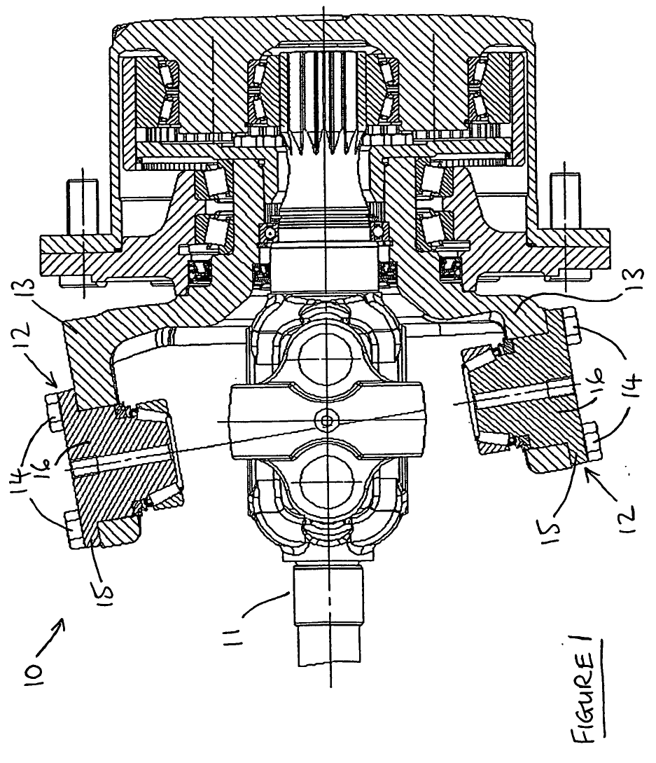

FIG. 1 is a vertical cross-section through one end of a driving and steering axle, ideally for agricultural or industrial vehicles,

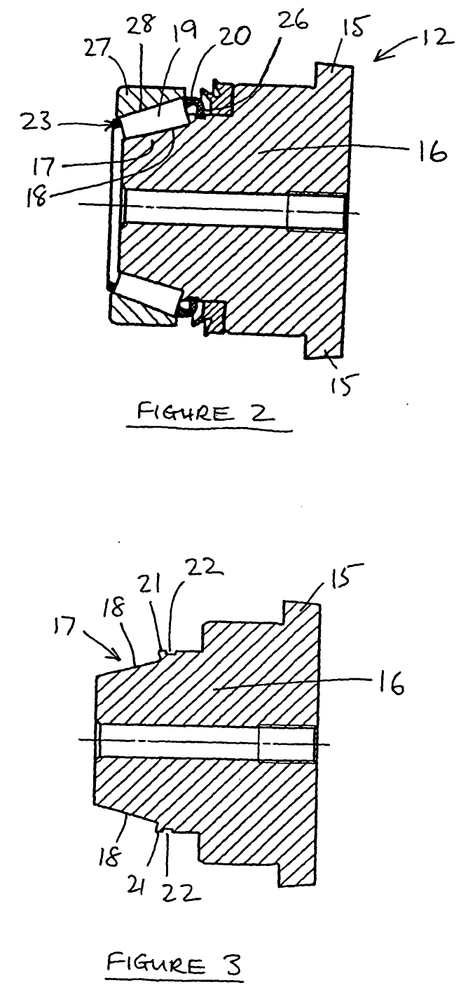

FIG. 2 is a cross-section in isolation of an integrated steering pivot illustrated in FIG. 1,

FIG. 3 is a cross-section of a pivot pin incorporated in the steering pivot of FIG. 2,

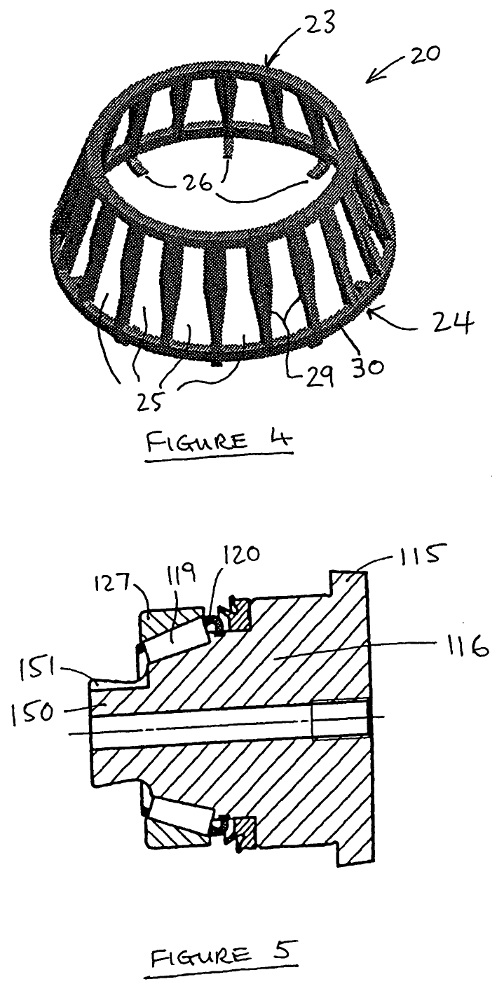

FIG. 4 is a perspective view of a roller cage utilised in the present invention, and

FIG. 5 is a cross-section similar to FIG. 2 of an alternative embodiment.

In FIGS. 1 to 4 there is shown a generally known integrated steering pivot package 10 for the driving and steering axle 11 of a vehicle which may, for example, be agricultural or industrial. In such an arrangement there are a pair of integrated steering pivots 12 at each end of the axle 11, each pivot 12 being secured with respect to a support arm 13 by means of bolts 14 which extend through respective holes in a flange portion 15 at one end of a pivot pin 16.

Each pivot pin 16, made for example from steel, has at its other end an integrally formed inner race section 17 which provides a part-conical inner raceway 18 for a set of tapered rollers 19. The rollers are retained in a roller cage 20, made for example from a suitable polymer compound. At the large end of the inner raceway, nearer the flange portion 15, is a peripheral rib 21 which acts as an abutment for the rollers 19. Further towards the flange 15 and immediately beyond the peripheral rib 21 is an annular groove 22.

The cage 20 is largely conventional in appearance having a narrow end 33, a large end 24 and a series of openings 25 spaced around its periphery for receiving the rollers 19. At the large end 24 there are a number of resilient inward projections 26 at spaced locations around the periphery. The cage 20 is clipped on to the pivot pin 16 by means of the projections 26 moving resiliently past the rib 21 and engaging in the annular groove 22 behind the rib 21. This retention of the cage 20 and associated rollers 19 relative to the inner race section 17 means that it is not necessary to provide a further rib, as is conventional, at the small end of the inner raceway, that is at the end of the inner raceway most remote from the flange 15.

Each pivot 12 also provides an outer race 27 which provides a part-conical outer raceway 28 for engagement with the rollers 19 in a conventional manner, the outer race 27 being connected to a further component of the vehicle which has not been shown.

It will be appreciated that this arrangement produces an integrated steering pivot which reduces the number of component parts and thus reduces the assembly time and cost.

In FIG. 5 there is shown a steering pivot pin 112 having a pivot 116 similar to that shown in FIGS. 1 to 3 (like parts having a prefix ‘1’). In this embodiment there is an axial extension 150 remote from the flange 115. The extension 150 has an axial groove 151 for receiving a sensor (not shown) for example an angular position sensor.

It will be appreciated that the number and precise form of the projections 26 is a matter of design choice but in the illustrated embodiment there are ten equispaced projections for a twenty roller cage, i.e. two rollers per projection. In addition the projections 26 have been located at the junctions of every other axial divider 29 and the large peripheral ring 30 defining the cage 20, but alternatives could be envisaged. Suitable modifications would be possible to accommodate cages of different size and construction. Also, other bearing types could be incorporated instead of the tapered roller bearing described above.

1. A steering pivot pin providing an integrally formed radially inner race defining a circumferentially extending inner raceway, and a cage retaining therein at spaced locations rolling elements which contact the inner raceway, the cage being retained relative to the pivot by means of a clip connection.

2. A steering pivot as claimed in claim 1 wherein there is also provided an outer race which defines a circumferentially extending outer raceway which engages the rolling elements.

3. A steering pivot as claimed in claim 1 wherein the rolling elements are tapered rollers and the inner and outer raceways are part-conical.

4. A steering pivot as claimed in claim 1 wherein the clip connection is constituted by resilient radially inward projections provided at spaced locations around the large end of the cage.

5. A steering pivot as claimed in claim 4 wherein the projections are received in a circumferential groove in the large outside diameter of the inner race.

6. A steering pivot as claimed in claim 5 wherein the large axial end of the inner raceway has a circumferential rib against which the rolling elements engage and the circumferential groove is provided immediately axially behind the rib.

7. A steering pivot as claimed in claim 6 wherein a seal element is provided behind the circumferential groove.

8. A steering pivot as claimed in claim 1 wherein the pivot pin has a flange at its end remote from the narrow end of the inner race, the flange having a number of holes for facilitating attachment to a support arm.

9. A steering pivot as claimed in claim 1 wherein the pivot pin has an axial extension beyond the narrow end of the inner race, the axial extension being adapted to receive a sensor.

10. A steering pivot as claimed in claim 9 wherein said axial extension has an axial groove for receiving a sensor.

11. In a steering axle of a vehicle, with the steering axle having support arms which pivot about a generally upright axis, an improved steering pivot for enabling one of the arms to pivot about the axis, said pivot comprising:
a pivot pin fitted into said one arm and having an inner raceway that is oblique to and is presented away from the axis, the pin also having an annular groove at one end of the raceway, with the groove opening away from the axis;
an outer raceway located around the inner raceway and being presented toward the axis and the inner raceway, the outer raceway being inclined with respect to the axis in the same direction that the inner raceway is inclined;
rolling elements arranged in a row between the inner raceway on the pin and the outer raceway; and
a cage having projections which project into the annular groove of the pin and prevent the cage and rolling elements from moving axially off the pivot pin in the absence of the outer race.

12. The combination according to claim 11 wherein the raceway has a large end and a small end, with the large end being located closest to the groove and the small end being at one end of the pin so that the rolling elements will move axially away from the groove and off the pivot pin in the absence of the engagement of the projections on the cage with the groove.

13. The combination according to claim 12 wherein the cage has openings and the rolling elements are received in the openings.

14. The combination according to claim 12 and further comprising an outer race located around the inner race, the outer raceway being on the outer race.

15. The combination according to claim 12 wherein the rolling elements are tapered rollers and the raceways are frustoconical.

16. The combination according to claim 12 wherein the projections on the cage are resilient.

17. The combination according to claim 16 wherein the cage is formed from a polymer.

18. The combination according to claim 12 wherein the pivot pin is received in the support arm and has a flange at its end that is remote from the end at which the inner raceway terminates, with the flange overlying the support arm; and
wherein the pin is secured to the support arm at the flange.

19. The combination according to claim 12 wherein the pivot is one of two spaced apart pivots, each having its pivot pin fitted to a different support arm, with the raceways of the pivots being inclined downwardly toward the space between the pivots.
